(19) United States
(12) Patent Application Publication
(10) Pub. No.: US 2002/0112735 A1
(43) Pub. Date: Aug. 22, 2002

(54) Nail file with plastic mirror

(76) Inventor: Il Young Park, Seoul (KR)

Correspondence Address: Cooper & Dunham LLP, 1185 Avenue of the Americas, New York, NY, 10036, US

(21) Appl. No.: 09/834,329

(22) Filed: Apr. 12, 2001

(30) Foreign Application Priority Data
Feb. 20, 2001 (KR) 2000-4363

(51) Int. Cl. B26B 13/22

(52) U.S. Cl. 132/73.5

(57) ABSTRACT

A nail file, provided with a plastic mirror for allowing a user to look into the mirror as desired, in addition to using the file for trimming, smoothing or shaping the fingernails, is disclosed. The nail file of this invention includes a board consisting of a soft resin sheet and a resin foam sheet laminated together into an integrated single board. A plastic mirror, coated with a reflective coat layer, is attached to the first surface of the single board, while a nail filing sheet is attached to the second surface of the single board. The board of the nail file may have a longitudinal shape rounded at each end thereof, or have a variety of shapes, such as a star shape, a heart shape or a flower shape.

### BACKGROUND OF THE INVENTION

1. Field of the Invention

The present invention relates to nail files used for trimming, smoothing, or shaping the fingernails and, more particularly, to a nail file provided with a plastic mirror for allowing a user to look into the mirror as desired, in addition to using the file for trimming, smoothing or shaping the fingernails.

2. Description of the Prior Art

As well known to those skilled in the art, conventional nail files are small files typically made of metal, and used for trimming, smoothing, or shaping the fingernails. The conventional nail files of metal have a series of ridges or points on one surface or opposite surfaces thereof for trimming, smoothing or shaping the fingernail surfaces as desired. On the other hand, emery boards have been proposed and used for trimming, smoothing, or shaping the fingernails in place of the nail files of metal. However, the conventional nail files or emery boards are problematic in that they only have a structure for trimming, smoothing, or shaping the fingernails.

On the other hand, most women carry portable glass mirrors for looking into the mirror as desired. However, such portable glass mirrors are somewhat large in their sizes, and are heavy in their weight, and so they are inconvenient to users. It is thus necessary to propose a mirror, which is light in its weight, thus being easily and simply carried by users and being convenient to the users.

### SUMMARY OF THE INVENTION

Accordingly, the present invention has been made keeping in mind the above problems occurring in the prior art, and an object of the present invention is to provide a nail file, which is provided with a plastic mirror for allowing a user to look into the mirror as desired, in addition to using the file for trimming, smoothing or shaping the fingernails, and which is easily and simply carried by a user, and is very convenient to the user.

In order to accomplish the above object, the primary embodiment of the present invention provides a nail file, comprising: a longitudinal board having a predetermined width and rounded at each end thereof, the longitudinal board consisting of a soft resin sheet and a resin foam sheet laminated together into an integrated single board, with a plastic mirror coated with a reflective coat layer and attached to the first surface of the single board, and a nail filing sheet attached to the second surface of the single board.

In another embodiment, the board of the nail file may have a variety of shapes. In the embodiment, the board consists of a soft resin sheet and a resin foam sheet laminated together into an integrated single board, with a plastic mirror coated with a reflective coat layer and attached to the first surface of the single board, and a nail filing sheet attached to the second surface of the single board in the same manner as that of the primary embodiment.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view of a nail file in accordance with the primary embodiment of the present invention;

FIG. 2 is an exploded perspective view of the nail file according to the primary embodiment of this invention;

FIG. 3 is a sectional view of the nail file according to the primary embodiment of this invention, showing the construction of the nail file;

FIGS. 4a, 4b and 4c are perspective views of nail files in accordance with the second, third and fourth embodiments of the present invention; and

FIGS. 5 and 6 are views, showing the operation of the nail file of this invention.

### DETAILED DESCRIPTION OF THE INVENTION

Reference now should be made to the drawings, in which the same reference numerals are used throughout the different drawings to designate the same or similar components.

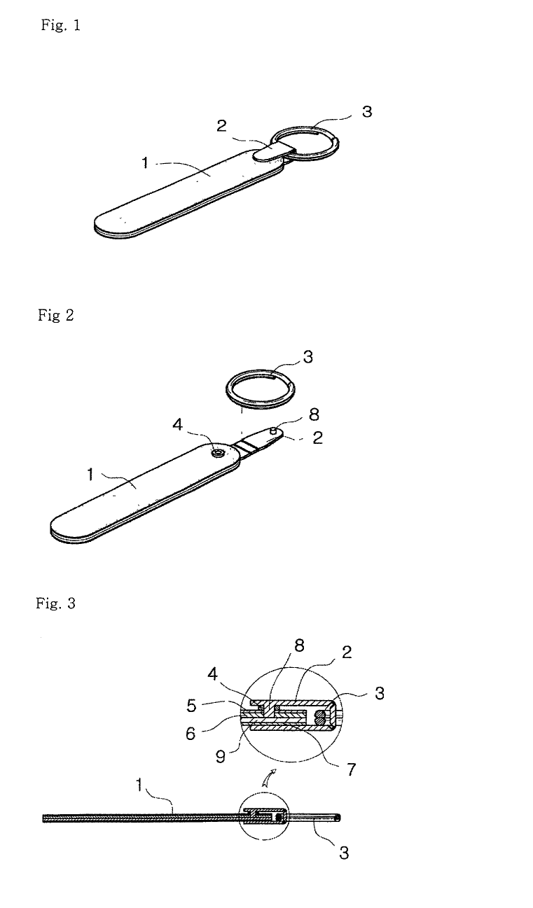

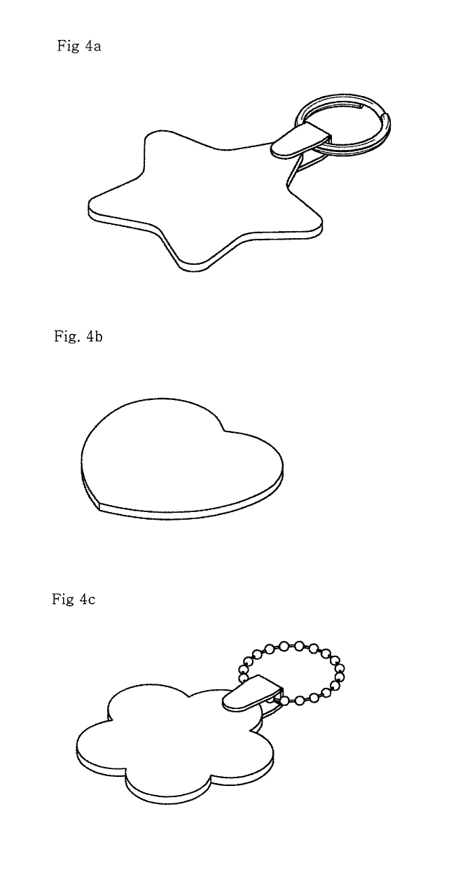

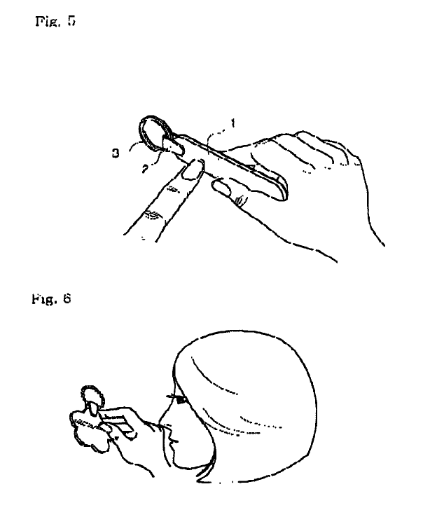

FIG. 1 is a perspective view of a nail file in accordance with the primary embodiment of the present invention. FIG. 2 is an exploded perspective view of the nail file of FIG. 1. FIG. 3 is a sectional view of the nail file of FIG. 1, showing the construction of the nail file. FIGS. 4a, 4b and 4c are perspective views of nail files in accordance with the second, third and fourth embodiments of the present invention. FIGS. 5 and 6 are views, showing the operation of the nail file of this invention.

As shown in FIGS. 1 to 3, the nail file according to the primary embodiment of this invention comprises a longitudinal board 1 having a predetermined width and rounded at each end thereof. This longitudinal board 1 consists of a soft resin sheet 6 and a resin foam sheet 9 laminated together into an integrated single board. A plastic mirror 7, coated with a reflective coat layer, is attached to the first surface of the single board, while a nail filing sheet 5 is attached to the second surface of the single board. The longitudinal board 1 is preferably and detachably connected to a ring 3 through a detachable locker 2, and so it is possible for a user to easily and simply carry the nail file of this invention while being less likely to lose it. The detachable connection of the ring 3 to the board 1 is accomplished by a snap fastener, consisting of a hole 4 provided on the board 1 and a projection 8 provided at the end of the locker 2.

In the second, third and fourth embodiments of the present invention, the profile of the board 1 may be selected from a variety of profiles, such as a star-shape profile of FIG. 4a, a heart-shaped profile of FIG. 4b and a flower-shaped profile of FIG. 4c. In each of the second, third and fourth embodiments of this invention, the laminated structure of the board 1 remains the same as that described for the primary embodiment. That is, the board 1 consists of a soft resin sheet 6 and a resin foam sheet 9, which are laminated together into an integrated single board. A plastic mirror 7, coated with a reflective coat layer, is attached to the first surface of the single board, while a nail filing sheet 5 is attached to the second surface of the single board. The nail files of the second to fourth embodiments of this invention provide the same operational effect as that of the primary embodiment. In the present invention, it should be understood that the nail file may be free from a ring as shown in FIG. 4b, or may be provided with a chain loop in place of the ring as shown in FIG. 4c.

As described above, the present invention provides a nail file provided with a plastic mirror for allowing a user to look into the mirror as desired, in addition to using the file for trimming, smoothing or shaping the fingernails. The nail file of this invention includes a board consisting of a soft resin sheet and a resin foam sheet laminated together into an integrated single board. A plastic mirror, coated with a reflective coat layer, is attached to the first surface of the single board, while a nail filing sheet is attached to the second surface of the single board.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A nail file, comprising:
a longitudinal board (1) having a predetermined width and rounded at each end thereof, said longitudinal board (1) consisting of a soft resin sheet (6) and a resin foam sheet (9) laminated together into an integrated single board, with a plastic mirror (7) coated with a reflective coat layer and attached to a first surface of said single board, and a nail filing sheet (5) attached to a second surface of said single board.

2. A nail file, comprising:
a board having a variety of shapes, and consisting of a soft resin sheet and a resin foam sheet laminated together into an integrated single board, with a plastic mirror coated with a reflective coat layer and attached to a first surface of said single board, and a nail filing sheet attached to a second surface of said single board.
